(19) United States
(12) Patent Application Publication
(10) Pub. No.: US 2021/0192967 A1
(43) Pub. Date: Jun. 24, 2021

(54) SYSTEM AND METHOD FOR VIRTUAL TARGET SIMULATION

(71) Applicant: Bob Ferris, Mesa, AZ (US)

(72) Inventor: Bob Ferris, Mesa, AZ (US)

(21) Appl. No.: 17/117,066

(22) Filed: Dec. 9, 2020

Related U.S. Application Data
(60) Provisional application No. 62/945,839, filed on Dec. 9, 2019.

(51) Int. Cl. G09B 9/00; G06F 3/01

(52) U.S. Cl. CPC G09B 9/003; G06F 3/011

(57) ABSTRACT

The most preferred embodiments of the present invention provide a system and method for creating a simulated human target in a simulated firearm training system. The simulated human target is represented on one or more screens using a simulated human target creation mechanism. The simulated human target mechanism comprises a series of modules that, taken together, provide a much more realistic simulated human target that can be used in a highly effective training simulation to create a more robust training environment.

### 1. TECHNICAL FIELD

The present invention relates generally to simulated firearms training and more specifically relates to systems and methods for creating computer generated or digital simulated targets representing human targets.

### 2. BACKGROUND ART

One of the most difficult firearms related skills is learning to engage a moving human target at a variety of distances. While difficult to develop and maintain this skill, it is a fundamental skill for the lethality of a fighting force. This is made more challenging since there are precious few ways of practicing such situations while preserving enough fidelity to embed valid skills transportable to the real world. On top of this, the ability to quickly and accurate hit a moving hostile human during the brief moments when they are exposed would greatly increase chances for mission success and decrease chances of dangerous return fire.

Most systems and methods in use today provide only very rudimentary simulated human targets in firearms simulation training. The human target may be created using a computer generated imagery (“CGI”) system or some other type of representation that can be displayed on a screen. These existing systems are usually not very sophisticated and provide little in the way of realism regarding engaging the simulated human target. For example, there is no realistic feedback regarding if your shot impacted on the simulated human target, due to a lack of response of the simulated human target to the virtual “hits” sustained in the simulation. This makes it very difficult, if not impossible, to provide realistic training to trainees using a simulated firearm training system. Accordingly, without providing enhanced systems and methods for creating and displaying a simulated human target, firearm training systems will continue to be suboptimal.

### BRIEF SUMMARY OF THE INVENTION

The most preferred embodiments of the present invention provide a system and method for creating a simulated human target in a simulated firearm training system. The simulated human target is represented on one or more screens using a simulated human target creation mechanism. This could also be screen(s) inside a goggle, to include an augmented reality glasses where the user sees the real-world as well as the addition of one or more CGI humans showing up on the screen of the goggle. The simulated human target mechanism comprises a series of modules that, taken together, provide a much more realistic simulated human target that can be used in a highly effective training simulation to create a more robust training environment.

Additionally, as part of the overall simulated firearm training system, the simulated human target mechanism will interact with a ballistic simulation mechanism that will provide input to the simulated human target mechanism to more accurately represent a human being during a real world encounter depicted as the simulated human target.

### BRIEF DESCRIPTION OF THE DRAWINGS

The various embodiments of the present invention will hereinafter be described in conjunction with the appended drawings, wherein like designations denote like elements, and

FIG. 1 is a block diagram of a system for simulating a human target in accordance with a preferred embodiment of the present invention;

FIG. 2 is a block diagram of the human target simulation mechanism in accordance with a preferred embodiment of the present invention;

FIG. 3 is a block diagram of a ballistic simulation mechanism in accordance with a preferred embodiment of the present invention; and

FIG. 4 is a flow chart of a method for simulating a human target in accordance with a preferred embodiment of the present invention.

### DETAILED DESCRIPTION OF INVENTION

In the most preferred embodiments of the present invention, a simulated firearm training system will typically comprise a computer control system with simulated firearm training system software, one or more screens (or goggles), one or more simulated firearms, one or more projectors to display a simulated training environment, one or more tracking and feedback sensors to track various inputs and outputs, and one or more simulated human targets displayed in the simulated training environment.

Alternatively, the simulated human target might be programmed to move erratically, change directions at random times, or move behind a simulated barricade or other shelter, making it more difficult to predict where the simulated human target is headed and more difficult to engage the simulated human target. The simulated human size and movements would be consistent with reality including the ground they are covering that would be modeled to be accurate to a stride distance and frequency, even if erratic so as to be maintained within physical and geospatial boundaries defined by real world physics and laws of nature.

At least one preferred embodiment of the present invention would be a simulated human target modeled relative to various levels of adrenaline consistent with ‘running for your life.’ In the most preferred embodiments of the present invention, the simulated human target would act naturally, for example, diving to get behind cover as quickly as possible. For each virtual shot taken by the trainee the ballistic simulation mechanism would calculate and model the 3-dimensional path the bullet would take in a real-world environment, including modeling ballistic variables such as wind, altitude, barometric pressure, humidity, temperature, rifling, aerodynamic co-efficient of the bullet, grains of gunpowder in the bullet, speed of the running human, etc.

In the most preferred embodiments of the present system, the simulated human target would be a 3-dimensional representation of a human using either traditional 3D graphics or volumetric video capture. Using the combination of accurate bullet telemetry generated by the ballistic simulation mechanism, couple with accurate simulated human movement generated by the simulated human target mechanism, the system will accurately determine if a bullet strikes the simulated human and if it does strike the simulated human, where exactly does the bullet impact, and with how much energy.

The simulated 3D human would have both a normal looking 3D exterior as well as a 3D interior. The interior would include modeling of the accurate locations of internal organs, such as brain, heart, main arteries, spine and lungs. The system will accurately determine what internal organs were hit, with what frequency, accounting for accumulated damage scoring, and then have the simulated human target respond accordingly and be displayed on one or more screens.

For example, if the virtual bullet impacted the simulated human target at a critical location in the head, then the simulated human target would respond as expected (e.g., by dying immediately). However, if the simulated human target was struck in the thigh, then the simulated human might have limited or no use of that part of their simulated body and the image of the simulated human target would be seen limping or otherwise incapacitated. Further, the system would have the option to simulate the amount of blood loss based on the location of the impact, so that even if there was no immediate impact, the loss of blood over time would simulate “bleeding out.” Additionally, the simulation scenario mechanism could be programmed to simulate a variety of locations, weapons, weather conditions, and physical obstacles.

A “training sequence” is predetermined to be as little as one shot fired, or however many shots were fired during one opportunity to hit a human running from one cover to another cover, or a much longer training session either timed or until a set objective is completed. At the conclusion of the trainee sequence the trainee is presented with a 3D graphical view of each bullet they fired for the sequence and selective zoomed in view of the simulated human and/or the simulated human's 3D internal organs (at selective levels of transparency).

Further, the trainee may be shown an accurate recreation of their sight picture when they fired the bullet as well as they are shown the ideal sight picture in order to hit the center of a selected region on the simulated human (the head or torso, for example). The system would take into account all the ballistic information for this training event, as calculated by the ballistic simulation mechanism, and based on the desire to impact a particular area, such as a lethal head shot, would display the ideal location to fire either during run-time and/or during debrief.

The trainee could then select to repeat the exact same training sequence, do the same sequence but with different wind/distance, do a selectively randomized new training session, or go back to the main setup screen. “Bullet time” would be a setting where they could follow the virtual bullet from the barrel until it comes to rest but at a slower speed at the end of the bullet's flight and with the camera following the path (e.g., a combination of real time trajectory and slow motion or even stop motion at or shortly before the moment of impact).

Another preferred embodiment of the present invention would include a review setting were the trainee and a trainer would be able to watch the bullet's trajectory, in slow motion, when nearby (within 7 feet, for example) the simulated human target, to see if, for example, the bullet went between the legs of the simulated human target as they sprinted between one location and another location (seeking cover or concealment, for example). In the case of using a visual display device Augmented Reality goggles, Mixed Reality goggles, or XR goggles, the user would see the real-world around them and the computer would scale the CGI simulated human target appropriately based on the distance from the user as well as track the virtual from the user as it travels towards or away from one or more CGI human(s) and/or the trainee.

Measurements are captured of each training sequence so performance changes over time can be tracked. In the most preferred embodiments of the present invention, some of the key measurements are the amount of time it took to impact the virtual human from the moment a threat was determined, the time it took to lethally impact the virtual human, number of hits or misses per unit time, and number of lethal hits per unit time.

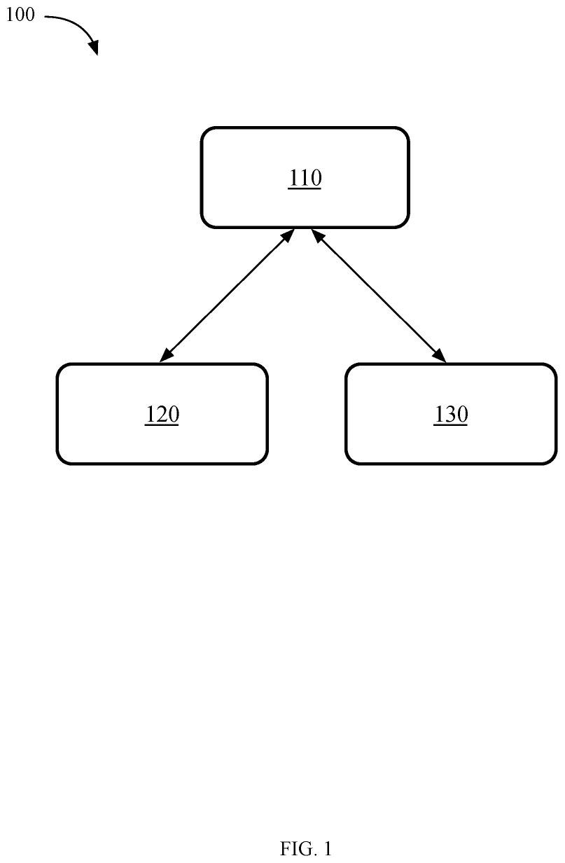

Referring now to FIG. 1, a simulated firearm training system 100 in accordance with a preferred embodiment of the present invention comprises a simulation environment 110, a scenario simulation mechanism 120, a simulated human target mechanism 130, and a ballistic simulation mechanism 140. The data passed back and forth from simulation environment 110, scenario simulation mechanism 120, and simulated human target mechanism 130, and ballistic simulation mechanism 140 all provide a realistic training scenario.

Simulation environment 110 comprises at least one visual display device (e.g. a screen, a monitor, VR goggles, or similar display device), an optional projector (if using a screen), at least one sensor, and a least one simulated firearm. These items are used by one or more trainees in a simulated firearm training scenario.

Scenario simulation mechanism 120, comprises a hardware and software combination that crates the audio and video signals sent to simulation environment 110 for display on one or more screens, monitors, or other display device such as a VR headset or goggles. Various training scenarios can be stored and retrieved for training purposes. In the most preferred embodiments of the present invention, the training scenarios are flexible and provide multiple training “branches” or logical paths, depending on the interactive decisions made by one or more trainees who are participating in the simulated firearm training exercise.

Simulated human target mechanism 130 most preferably comprises a software mechanism that accepts input from the scenario simulation mechanism 110 and Ai 140.

Ballistic simulation mechanism 140 most preferably comprises a software mechanism that calculates the movement, trajectory, and impact of a simulated bullet or other type of round generated by a simulated firearm, using a variety of pre-programmed and/or user definable variables. This enables ballistic simulation mechanism 140 to accurately simulate multiple calibers of bullets as well as loads for training and simulation purposes.

Scenario simulation mechanism 110 allows one or more trainees to engage one or more digital simulated human targets generated by simulated human target mechanism 120. The preference is for the simulated weapon to be as accurate a reproduction of the actual weapon as possible in form, fit and function. Next, each trainee is presented with a displayed image of a digital simulated environment (such as rocky terrain or an urban area) with or without digital simulated human targets. Either remote controlled or at a pre-determined time, a simulated human target can fire back at the trainee. The trainee might hear the sound, see the flash and/or feel a sensation of pain through an electric impulse device. The simulated human target might next sprint towards cover, such as a large rock or side of a building, etc.

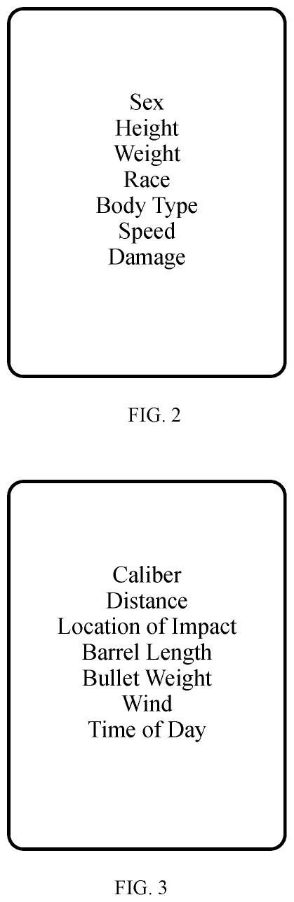

Referring now to FIG. 2, a block diagram of a human target simulation mechanism in accordance with a preferred embodiment of the present invention is depicted. With the human target simulation mechanism, various physical characteristics of a digital human being are modeled including sex, height, weight, race, body type, speed, damages (which is adjusted over time), etc.)

Referring now to FIG. 3, a block diagram of a ballistic simulation mechanism 140 in accordance with a preferred embodiment of the present invention is depicted. By configuring ballistic simulation mechanism 140, various physical characteristics of a projectile fired from a real world firearm are modeled including caliber, distance to target, location of impact on target, barrel length of the firearm, weight of the bullet, wind, time of day, number of bullets fired, number of bullet impacts, timing between the various impacts, etc. These variables and physical characteristics may be pre-programmed or user configurable variables.

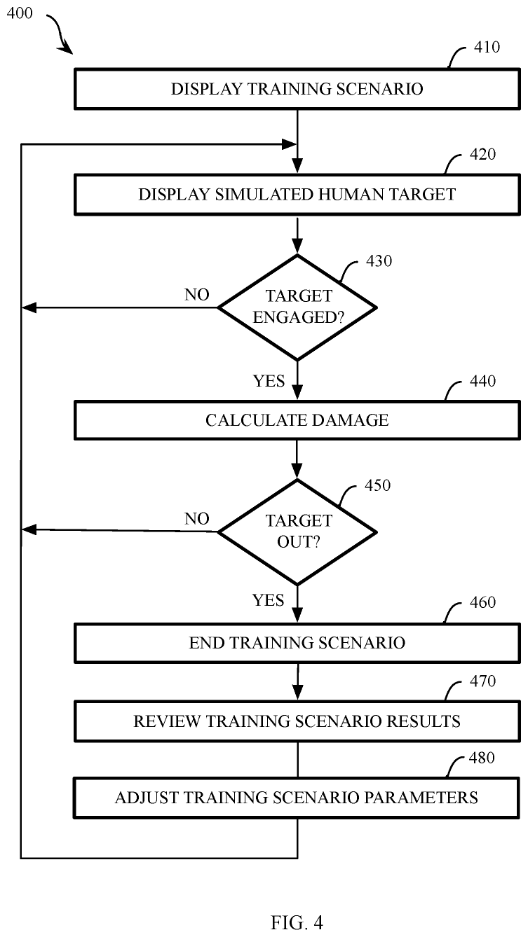

Referring now to FIG. 4, a method 400 for training one or more trainees in a simulated firearm training environment to engage one or more simulated human targets for training purposes. As shown in FIG. 4, a training scenario is displayed on visual display device (STEP 410) and a simulated human target is also displayed (STEP 420). Based on the actions of a trainee, as tracked, measured, and reported by various sensors and feedback devices placed in the training environment (e.g., laser emitters, laser sensors, sound actuators, cameras, etc.) it can be determined whether or not a simulated human target has been engaged (STEP 430).

If the simulated human target has not been engaged (STEP 430=“NO”), then the training scenario will continue to progress and the simulated human target will continue to be displayed for potential engagement (step 420). If the simulated human target has been engaged (STEP 430=“YES”), then the damage to the simulated human target will be calculated based on a number of factors including the calculations provided by the ballistic simulation mechanism (STEP 440).

The training scenario can continue until the target is neutralized or “out” of the training scenario (STEP 450). If the simulated human target is not “out” (STEP 450=“NO”), then the scenario will continue. However, if the simulated human target is “out” (STEP 450=“YES”), then the training scenario can be terminated (STEP 460) and the results of the training scenario can be reviewed and evaluate (STEP 470). It should be noted that STEP 470 may include the step of creating a performance score for each trainee as that trainee completes each training scenario. In that fashion, the performance of one trainee can be compared to the performance of other trainees and a given trainee's performance over time can be tracked and compared for purposes of measuring the effect of repetitive training sessions.

In closing, it is to be understood that although aspects of the present specification are highlighted by referring to one or more specific embodiments, those skilled in the art will readily appreciate that these disclosed embodiments are only illustrative of the principles of the subject matter disclosed herein. For example, although the disclosure refers to the various preferred embodiments of the present invention primarily in conjunction with certain hardware and software for specific application environments, those skilled in the art will recognize that the various embodiments of the present invention are suitable for use in conjunction with other situations where it is desirable to provide simulated firearms training.

Therefore, it should be understood that the disclosed subject matter is in no way limited to a particular methodology, protocol, and/or material, etc., described herein. As such, various modifications or changes to or alternative configurations of the disclosed subject matter can be made in accordance with the teachings herein without departing from the spirit of the present specification. Further, the terminology used herein is for the purpose of describing particular embodiments only, and is not intended to limit the scope of the present disclosure, which is defined solely by the claims. Accordingly, embodiments of the present disclosure are not limited to those precisely as shown and described.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar references used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as” or “for example”) provided herein is intended merely to better illuminate the present disclosure and does not pose a limitation on the scope of the embodiments otherwise claimed. No language in the present specification should be construed as indicating any non-claimed element essential to the practice of the disclosed embodiments.

1. A simulated firearm training system comprising:
a simulation environment;
a scenario simulation mechanism;
a simulated human target mechanism; and
a ballistic simulation mechanism.

2. The simulated firearm training system of claim 1 wherein the simulation environment comprises:
at least one visual display device;
at least one sensor; and
at least one simulated firearm.

3. The simulated firearm training system of claim 1 wherein the scenario simulation mechanism comprises a software mechanism that generates a simulated firearms training scenario to display to the at least one trainee.

4. The simulated firearm training system of claim 1 wherein the simulated human target mechanism comprises a software mechanism that generates a plurality of physical characteristics associated with a digital simulated human target.

5. The simulated firearm training system of claim 4 wherein the plurality of physical characteristics associated with the digital simulated human target include at least one of sex, height, weight, race, body type, speed, and accumulated damage.

6. The simulated firearm training system of claim 1 wherein the ballistic simulation mechanism comprises a software mechanism that selects at least one of a plurality of variables for simulation of a projectile for simulated firearms training.

7. The simulated firearm training system of claim 6 wherein the at least one of a plurality of variables comprises at least one of caliber, distance to target, location of impact on target, barrel length of the firearm, weight of the bullet, wind speed, time of day, number of bullets fired, number of bullet impacts, and timing between the various impacts.

8. The simulated firearm training system of claim 6 wherein the at least one of a plurality of variables comprises a plurality of variables including caliber, distance to target, location of impact on target, barrel length of the firearm, weight of the bullet, wind speed, time of day, number of bullets fired, number of bullet impacts, and timing between the various impacts.

9. The simulated firearm training system of claim 1 further comprising a plurality of performance reports based on a performance of the at least one trainee during a plurality of training exercises.

10. The simulated firearm training system of claim 1 wherein
the scenario simulation mechanism comprises a software mechanism that generates a simulated firearms training scenario to display to the at least one trainee;
the simulated human target mechanism comprises a software mechanism that generates a plurality of physical characteristics associated with a digital simulated human target;
the plurality of physical characteristics associated with the digital simulated human target include at least one of sex, height, weight, race, body type, speed, and accumulated damage; and
wherein the ballistic simulation mechanism comprises a software mechanism that selects at a plurality of variables for simulation of a projectile for simulated firearms training, the plurality of variables including caliber, distance to target, location of impact on target, barrel length of the firearm, weight of the bullet, wind speed, time of day, number of bullets fired, number of bullet impacts, and timing between the various impacts.

11. A method for simulated firearms training comprising the steps of:
displaying a computer generated training scenario to at least one trainee;
displaying at least one simulated human target in conjunction with the computer generated training scenario;
monitoring and tracking a plurality of simulated projectiles generated by a ballistic simulation mechanism in conjunction with at least one simulated weapon wielded by the at least one trainee;
continuing to display the computer generated training scenario to the at least one trainee until the objective of the computer generated training scenario has been met; and
ending the computer generated training scenario.

12. The method of claim 11 wherein the step of displaying a computer generated training scenario to at least one trainee comprises the step of displaying the computer generated training scenario to the at least one trainee using at least one of a projector and screen combination or a virtual/augmented reality headset.

13. The method of claim 11 wherein the step of continuing to display the computer generated training scenario to the at least one trainee until the objective of the computer generated training scenario has been met comprises the steps of:
tracking the performance of the at least one trainee by a plurality of sensors and a plurality of feedback devices; and
using the ballistic simulation mechanism to measure or calculate the simulated impact of the plurality of simulated projectiles directed towards the at least one simulated human target by the at least one trainee.
